(19) United States
(12) Patent Application Publication
(10) Pub. No.: US 2025/0047422 A1
(43) Pub. Date: Feb. 6, 2025

(54) HARQ-ACK CODEBOOK CONFIGURATION METHOD AND APPARATUS, HARQ-ACK CODEBOOK DECODING METHOD AND APPARATUS, DEVICE, AND STORAGE MEDIUM

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 18/694,560

(22) PCT Filed: Sep. 27, 2021
(86) PCT No.: PCT/CN2021/121072

§ 371 Date: Mar. 22, 2024

(51) Int. Cl. H04L 1/1829; H04L 1/1812

(52) U.S. Cl. CPC H04L 1/1848; H04L 1/1812; H04L 1/1861

(57) ABSTRACT

Provided in the present disclosure are a HARQ-ACK codebook configuration method and apparatus, a HARQ-ACK codebook decoding method and apparatus, a device, and a storage medium. The HARQ-ACK codebook configuration method is performed by user equipment, comprises: determining a timing K1 set in a second scenario on the basis of a timing K1 set in a first scenario and a timing K0 set in the second scenario; and configuring a HARQ-ACK codebook on the basis of the timing K1 set in the second scenario. By using the method, a feedback window of a codebook based on a timing K1 set in a second scenario can include all PDSCHs scheduled by a piece of DCI.

### TECHNICAL FIELD

The present disclosure relates to the field of wireless communication technology, and in particular, to a HARQ-ACK codebook configuration and decoding method, apparatus, device and storage medium.

### BACKGROUND

Type1 codebook is a HARQ-ACK (Hybrid Automatic Repeat Request Acknowledgment) feedback method with a fixed codebook size, in one HARQ-ACK physical uplink control channel (PUCCH), the HARQ-ACK for the valid candidate physical downlink shared channel (PDSCH) on all time slots in a fixed-size feedback window shall be feedback.

In NR 52.6-71 GHz, physical downlink control channel (PDCCH) scheduling multiple PDSCH time slots, that is, multi-slot PDSCH scheduling scenario, will be introduced. Due to the introduction of multi-slot PDSCH scheduling, determining the feedback window of the Type1 codebook based only on the K1 set in a single slot scheduling scenario may result in the Type1 codebook not fully containing the slots of all the PDSCH scheduled by the downlink control information (DCI).

### SUMMARY

In view of this, the present disclosure provides a HARQ-ACK codebook configuration and decoding method, apparatus, device and storage medium.

According to a first aspect of an embodiment of the present disclosure, a hybrid automatic repeat request acknowledgment (HARQ-ACK) response codebook configuration method is provided. The method is performed by user equipment, including:
determining a timing K1 set in a second scenario based on a timing K1 set in a first scenario and a timing K0 set in the second scenario; and
configuring the HARQ-ACK codebook based on the timing K1 set in the second scenario;
wherein, each timing k1 in the timing K1 set is a time interval between a time unit for transmitting a physical downlink shared channel (PDSCH) and a time unit for transmitting a physical uplink control channel (PUCCH), and each timing k0 in the timing K0 set is a time interval between the time unit for transmitting the physical downlink shared channel (PD SCH) and a time unit of transmitting a physical downlink control channel (PDCCH); and
the first scenario is a scenario in which a single PDSCH time slot is scheduled through the PDCCH, and the second scenario is a scenario in which multiple PDSCH time slots are scheduled through the PDCCH.

In an implementation, the timing K0 set in the second scenario includes at least one timing K0 group, each timing K0 group includes a plurality of timing K0, and each timing K0 group corresponds to a time domain resource scheduling mode in the second scenario.

In an implementation, the method further includes:
receiving first configuration information from a network device, wherein the first configuration information includes information indicating the timing K1 set in the first scenario; or
obtaining the timing K1 set in the first scenario based on a communication protocol.

In an implementation, the method further includes:
receiving second configuration information from a network device, wherein the second configuration information includes information indicating the timing K0 set in the second scenario.

In an implementation, the method further includes:
receiving second configuration information from a network device, wherein the second configuration information includes a time domain resource allocation (TDRA) table.

In an implementation, determining the timing K1 set in the second scenario based on the timing K1 set in the first scenario and the timing K0 set in the second scenario includes determining the timing K1 set in the second scenario based on following formula:

$$\{ K {1}^{′} \} = \{ K 1 \} ⋃ {\{ k {1}_{i} + k {0}_{m} - k {0}_{r , min} \}}_{i - 0 , r - 0 , m - 0}^{i = L - 1 , r = R - 1 , m = {M}_{r} - 1}$$

wherein, K1′ is the timing K1 set in the second scenario, K1 is the timing K1 set in the first scenario, k1ᵢ is an i-th timing k1 comprised in the timing K1 set in the first scenario, k0_{r,m} is an m-th timing k0 comprised in a r-th row containing multiple k0 in a TDRA table, k0_{r,min} is a minimum timing k0 comprised in the r-th row containing multiple k0, L is a number of timing k1 comprised in the timing K1 set in the first scenario, R is a number of rows containing multiple sequences k0 in the TDRA table, and Mᵣ is a number of timing k0 comprised in the r-th row containing multiple k0.

In an implementation, configuring the HARQ-ACK codebook based on the timing K1 set in the second scenario includes:
determining a feedback window corresponding to the HARQ-ACK codebook based on the timing K1 set in the second scenario.

In an implementation, the HARQ-ACK codebook is a Type1 codebook.

According to a second aspect of the embodiments of the present disclosure, a method for decoding a hybrid automatic repeat request acknowledgment (HARQ-ACK) response codebook is provided, the method is performed by network device, includes:
determining a timing K1 set in a second scenario based on a timing K1 set in a first scenario and a timing K0 set in the second scenario;
receiving the HARQ-ACK codebook from a user equipment; and
decoding the HARQ-ACK codebook based on the timing K1 set in the second scenario;
wherein, each timing k1 in the timing K1 set is a time interval between a time unit for transmitting a physical downlink shared channel (PDSCH) and a time unit for transmitting a physical uplink control channel (PUCCH), and each timing k0 in the timing K0 set is a time interval between the time unit for transmitting the physical downlink shared channel (PD SCH) and a time unit of transmitting a physical downlink control channel (PDCCH); and
the first scenario is a scenario in which a single PDSCH time slot is scheduled through the PDCCH, and the second scenario is a scenario in which multiple PDSCH time slots are scheduled through the PDCCH.

In an implementation, the timing K0 set in the second scenario includes at least one timing K0 group, and the timing K0 group corresponds to a plurality of timing k0 of a time domain resource scheduling mode in the second scenario.

In an implementation, the method further includes:
obtaining the timing K1 set in the first scenario based on a communication protocol.

In an implementation, the method further includes:
obtaining the timing K0 set in the second scenario based on a time domain resource allocation (TDRA) table.

In an implementation, determining the timing K1 set in the second scenario based on the timing K1 set in the first scenario and the timing K0 set in the second scenario includes determining the timing K1 set in the second scenario based on following formula:

$$\{ K {1}^{′} \} = \{ K 1 \} ⋃ {\{ k {1}_{i} + k {0}_{r , m} - k {0}_{r , min} \}}_{i = 0 , r = 0 , m = 0}^{i = L - 1 , r = R - 1 , m = {M}_{r} - 1}$$

wherein, K1′ is the timing K1 set in the second scenario, K1 is the timing K1 set in the first scenario, k1ᵢ is an i-th timing k1 comprised in the timing K1 set in the first scenario, k0_{r,m} is an m-th timing k0 comprised in a r-th row containing multiple k0 in a TDRA table, k0_{r,min} is a minimum timing k0 comprised in the r-th row containing multiple k0, L is a number of timing k1 comprised in the timing K1 set in the first scenario, R is a number of rows containing multiple sequences k0 in the TDRA table, and Mᵣ is a number of timing k0 comprised in the r-th row containing multiple k0.

In an implementation, the HARQ-ACK codebook is a Type1 codebook.

According to a third aspect of the embodiments of the present disclosure, an apparatus for configurating a hybrid automatic repeat request acknowledgment (HARQ-ACK) response codebook is provided, the apparatus is applied in a user equipment, includes:
a processing module, configured to determine a timing K1 set in a second scenario based on a timing K1 set in a first scenario and a timing K0 set in the second scenario; and
configure the HARQ-ACK codebook based on the timing K1 set in the second scenario;
wherein, each timing k1 in the timing K1 set is a time interval between a time unit for transmitting a physical downlink shared channel (PDSCH) and a time unit for transmitting a physical uplink control channel (PUCCH), and each timing k0 in the timing K0 set is a time interval between the time unit for transmitting the physical downlink shared channel (PD SCH) and a time unit of transmitting a physical downlink control channel (PDCCH); and
the first scenario is a scenario in which a single PDSCH time slot is scheduled through the PDCCH, and the second scenario is a scenario in which multiple PDSCH time slots are scheduled through the PDCCH.

According to a fourth aspect of the embodiments of the present disclosure, an apparatus for decoding a hybrid automatic repeat request acknowledgment (HARQ-ACK) response codebook is provided, the method is applied in a network device, includes:
a processing module, configured to determine a timing K1 set in a second scenario based on a timing K1 set in a first scenario and a timing K0 set in the second scenario;
a receiving module, configured to receive the HARQ-ACK codebook from a user equipment; and
a decoding module, configured to decode the HARQ-ACK codebook based on the timing K1 set in the second scenario;
wherein, each timing k1 in the timing K1 set is a time interval between a time unit for transmitting a physical downlink shared channel (PDSCH) and a time unit for transmitting a physical uplink control channel (PUCCH), and each timing k0 in the timing K0 set is a time interval between the time unit for transmitting the physical downlink shared channel (PDSCH) and a time unit of transmitting a physical downlink control channel (PDCCH); and
the first scenario is a scenario in which a single PDSCH time slot is scheduled through the PDCCH, and the second scenario is a scenario in which multiple PDSCH time slots are scheduled through the PDCCH.

According to a fifth aspect of the embodiments of the present disclosure, a mobile terminal is provided, including:
a processor; and
a memory configured to store executable instructions of the processor;
wherein, the processor is configured to execute the executable instructions in the memory to implement steps of the above method for configuring the hybrid automatic repeat request acknowledgment (HARQ-ACK) response codebook.

According to a sixth aspect of the embodiments of the present disclosure, a network side device provided, including:
a processor; and
a memory configured to store executable instructions of the processor;

Wherein, the processor is configured to execute the executable instructions in the memory to implement steps of the above method for decoding the hybrid automatic repeat request acknowledgment (HARQ-ACK) response codebook.

According to a seventh aspect of the embodiments of the present disclosure, a non-transitory computer-readable storage medium having executable instructions stored thereon is provided, wherein when the executable instructions are executed by a processor, steps of the above method for configuring the hybrid automatic repeat request acknowledgment (HARQ-ACK) response codebook or the above method for decoding the hybrid automatic repeat request acknowledgment (HARQ-ACK) response codebook.

The technical solution provided by the embodiments of the present disclosure may include the following beneficial effects: the timing K1 set in the second scenario is determined in combination with the timing K0 set in the second scenario, so that the feedback window of the codebook based on the timing K1 set in the second scenario can include all PDSCHs scheduled by one DCI, so that HARQ-ACK of multi-transmission time interval PDSCH can be fed back in one HARQ-ACK codebook. Moreover, network device can accurately decode the HARQ-ACK codebook to achieve efficient hybrid automatic retransmission.

It is to be understood that both the foregoing general description and the following detailed description are exemplary and explanatory only and are not restrictive of the present disclosure.

### BRIEF DESCRIPTION OF THE DRAWINGS

The drawings described here are used to provide a further understanding of the embodiments of the present disclosure and constitute a part of this application. The schematic embodiments of the embodiments of the present disclosure and their descriptions are used to explain the embodiments of the present disclosure and do not constitute an undue limitation of the embodiments of the present disclosure. In the attached picture:

The accompanying drawings, which are incorporated in and constitute a part of this specification, illustrate embodiments consistent with embodiments of the disclosure and together with the description, serve to explain principles of embodiments of the disclosure.

FIG. 1 is a flow chart of a HARQ-ACK codebook configuration method according to an exemplary embodiment;

FIG. 2 is a flow chart of a HARQ-ACK codebook configuration method according to an exemplary embodiment;

FIG. 3 is a flow chart of a HARQ-ACK codebook configuration method according to an exemplary embodiment;

FIG. 4 is a flow chart of a HARQ-ACK codebook configuration method according to an exemplary embodiment;

FIG. 5 is a flow chart of a HARQ-ACK codebook configuration method according to an exemplary embodiment;

FIG. 6 is a flow chart of a HARQ-ACK codebook configuration method according to an exemplary embodiment;

FIG. 7 is a flow chart of a HARQ-ACK codebook decoding method according to an exemplary embodiment;

FIG. 8 is a flow chart of a HARQ-ACK codebook decoding method according to an exemplary embodiment;

FIG. 9 is a flow chart of a HARQ-ACK codebook decoding method according to an exemplary embodiment;

FIG. 10 is a flow chart of a HARQ-ACK codebook decoding method according to an exemplary embodiment;

FIG. 11 is a block diagram of a HARQ-ACK codebook configuration apparatus according to an exemplary embodiment;

FIG. 12 is a block diagram of a HARQ-ACK codebook decoding apparatus according to an exemplary embodiment;

FIG. 13 is a structural diagram of a HARQ-ACK codebook configuration device according to an exemplary embodiment;

FIG. 14 is a structural diagram of a HARQ-ACK codebook decoding device according to an exemplary embodiment.

### DETAILED DESCRIPTION

The embodiments of the present disclosure will now be further described with reference to the accompanying drawings and specific implementation modes.

Exemplary embodiments will be described in detail herein, examples of which are illustrated in the accompanying drawings. When the following description refers to the drawings, the same numbers in different drawings refer to the same or similar elements unless otherwise indicated. The implementations described in the following exemplary embodiments do not represent all implementations consistent with embodiments of the present disclosure. Rather, they are merely examples of apparatus and methods consistent with aspects of the disclosure as detailed in the appended claims.

It should be noted that an embodiment of the present disclosure may include multiple steps; for convenience of description, these steps are numbered; however, these numbers do not limit the execution time slots and execution order between the steps; these steps It can be implemented in any order, and the embodiment of the present disclosure does not limit this.

In a multi-slot PDSCH scheduling scenario, the HARQ-ACKs of multiple PDSCHs scheduled by a DCI are fed back in the same PUCCH. The slot of the PUCCH for HARQ-ACK feedback of the multiple PDSCHs is determined according to the k1 in the scheduled DCI and the time slot position of the last PDSCH. Due to the introduction of multi-slot PDSCH scheduling, determining the feedback window of the Type1 codebook based only on the K1 set in the single-slot scheduling scenario may result in the Type1 codebook not fully including the slots of all the PDSCH scheduled by the DCI.

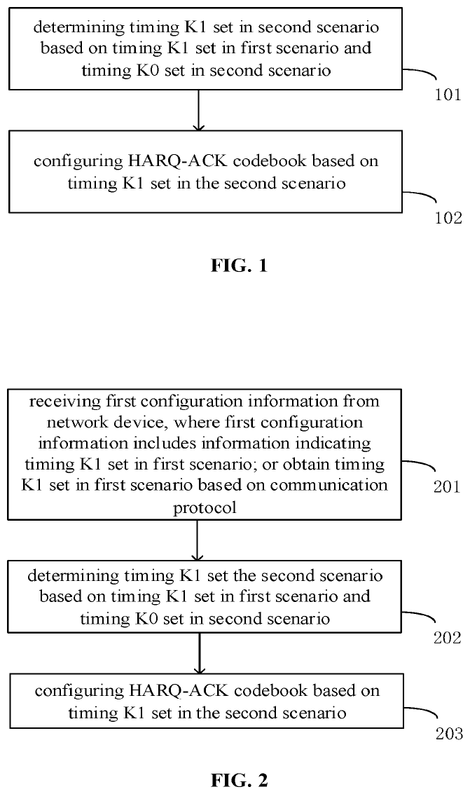

Embodiments of the present disclosure provide a HARQ-ACK codebook configuration method, which is performed by user equipment. This method can be executed independently or in conjunction with any other embodiment of the present disclosure. FIG. 1 is a flow chart of a HARQ-ACK codebook configuration method according to an exemplary embodiment. As shown in FIG. 1, the method includes:

Step 101, determining a timing K1 set in a second scenario based on a timing K1 set in a first scenario and a timing K0 set in the second scenario; and

Step 102, configuring the HARQ-ACK codebook based on the timing K1 set in the second scenario;
wherein, each timing k1 in the timing K1 set is a time interval between a time unit for transmitting a physical downlink shared channel (PDSCH) and a time unit for transmitting a physical uplink control channel (PUCCH), and each timing k0 in the timing K0 set is a time interval between the time unit for transmitting the physical downlink shared channel (PD SCH) and a time unit of transmitting a physical downlink control channel (PDCCH); and
the first scenario is a scenario in which a single PDSCH time slot is scheduled through the PDCCH, and the second scenario is a scenario in which multiple PDSCH time slots are scheduled through the PDCCH.

In one embodiment, the user equipment obtains the timing K1 set in the scenario of scheduling a single PDSCH time slot through PDCCH and the timing K0 set in the scenario of scheduling multiple PDSCH time slots through PDCCH, and based on the above obtained timing K1 set and timing K0 set, determines the timing K1 set in the scenario of scheduling multiple PDSCH time slots through PDCCH. Then, the HARQ-ACK codebook is configured based on the timing K1 set in the scenario of scheduling multiple PDSCH time slots through PDCCH.

In one embodiment, the user equipment receives from the network device the timing K1 set in the first scenario configured by the network device, or obtains the timing K1 set in the first scenario based on the communication protocol. In one implementation, the user equipment receives from the network device a timing K0 set in the second scenario configured by the network device. In one embodiment, the user equipment receives a time domain resource allocation (TDRA) table from the network device, and obtains the timing K0 set in the second scenario based on the TDRA table.

In the above embodiment, the timing K1 set in the second scenario is determined based on the timing K1 set in the first scenario and the timing K0 set in the second scenario, so that the feedback window of the codebook of the timing K1 set in the second scenario can include all PDSCHs scheduled by one DCI, so that HARQ-ACK of multi-transmission time interval PDSCH can be fed back in one HARQ-ACK codebook.

The embodiment of the present disclosure provides a HARQ-ACK codebook configuration method, which is performed by user equipment; the method can be executed independently, or can be executed in conjunction with any other embodiment of the embodiment of the present disclosure. In the embodiment, the timing K0 set in the second scenario includes at least one timing K0 group, each timing K0 group includes multiple timings k0, and each timing K0 group corresponds to a time domain resource scheduling mode in the second scenario.

In one embodiment, the timing K0 set in the second scenario includes multiple timing K0 groups, each timing K0 group includes multiple timing k0, and each timing K0 group corresponds to a time domain resource scheduling mode in the second scenario.

In one implementation, the timing K0 set in the second scenario is obtained based on a time domain resource allocation (TDRA) table configured by the network device. The TDRA table is shown in Table 1:

TABLE 1
TDRA table

| | DMRS | | | | |
|---|---|---|---|---|---|
| row | TypeA | PDSCH | | | |
| index | location | mapping type | k0 | S | L |
| 1 | 2 | Type A | 0 | 2 | 6 |
| 2 | 3 | Type A, Type A, | 0, 1, 1, 2 | 3, 3, 8, 11 | 11, 9, 4, 2 |
| 3 | 2 | Type B, Type B, | 1, 2, 3, 4, | 3, 3, 3, 6, | 11, 11, 11, |
| | | Type A, Type A, | 5, 6, 7, 8 | 6, 6, 8, 8 | 8, 8, 8, 4, 4 |
| | | Type A, | | | |
| | | Type B, Type B, | | | |
| | | Type B, Type B, | | | |
| | | Type B | | | |
| 4 | 3 | Type A | 0 | 3 | 6 |
| 5 | 2 | Type B | 0 | 4 | 4 |

In the embodiment, the DMRS represents the demodulation reference signal (DeModulation Reference Signal).

In the embodiment, each row of the TDRA table corresponds to a time domain resource scheduling mode. The time domain resource scheduling modes identified by row indexes 2 and 3 correspond to multiple timings k0. Therefore, row indexes 2 and 3 respectively correspond to the timing K0 group (0, 1, 1, 2) and (1, 2, 3, 4, 5, 6, 7, 8). At this time, the timing K0 set in the second scenario includes timing K0 groups (0, 1, 1, 2) and (1, 2, 3, 4, 5, 6, 7, 8).

It can be understood that each element in Table 1 exists independently, and these elements are exemplarily listed in the same table, but it does not mean that all elements in the table must exist at the same time as shown in the table. The value of each element does not depend on the value of any other element in Table 1. Therefore, those skilled in the art can understand that the value of each element in Table 1 is an independent embodiment.

In the above embodiment, the timing K1 set in the second scenario is determined in combination with the timing K0 set in the second scenario, so that the feedback window of the codebook based on the timing K1 set in the second scenario can include all the PDSCHs scheduled by the DCI, so that the HARQ-ACK of the multi-transmission time interval PDSCH can be fed back in one HARQ-ACK codebook.

In the above embodiment, the timing K1 set in the second scenario is determined in combination with the timing K0 set in the second scenario, so that the feedback window of the codebook based on the timing K1 set in the second scenario can include all the PDSCHs scheduled by the DCI, so that the HARQ-ACK of the multi-transmission time interval PDSCH can be fed back in one HARQ-ACK codebook.

Embodiments of the present disclosure provide a HARQ-ACK codebook configuration method, which is performed by user equipment. This method can be executed independently or in conjunction with any other embodiment of the present disclosure. FIG. 2 is a flow chart of a HARQ-ACK codebook configuration method according to an exemplary embodiment. As shown in FIG. 2, the method includes:

Step 201: receiving first configuration information from a network device, where the first configuration information includes information indicating a timing K1 set in a first scenario; or obtain the timing K1 set in the first scenario based on a communication protocol;

Step 202: determining the timing K1 set in the second scenario based on the timing K1 set in the first scenario and the timing K0 set in the second scenario; and

Step 203: configuring the HARQ-ACK codebook based on the timing K1 set in the second scenario;

In the embodiment, each timing k1 in the timing K1 set is the time interval between the time unit for transmitting the physical downlink shared channel (PDSCH) and the time unit for transmitting the physical uplink control channel (PUCCH), and each timing k0 in the timing K0 set is the time interval between the time unit for transmitting the PDSCH and the time unit for transmitting the physical downlink control channel (PDCCH); and

The first scenario is a scenario in which a single PDSCH time slot is scheduled through the PDCCH, and the second scenario is a scenario in which multiple PDSCH time slots are scheduled through the PDCCH.

In one embodiment, the user equipment receives the first configuration information from the network device, obtains the timing K1 set in the first scenario based on the first configuration information, and determines the timing K1 set in the second scenario based on the timing K1 set in the first scenario and the timing K0 set in the second scenario. Then configure the HARQ-ACK codebook based on the timing K1 set in the second scenario.

In one embodiment, the user equipment obtains the timing K1 set in the first scenario based on the communication protocol, and determines the timing K1 set in the second scenario based on the timing K1 set in the first scenario and the timing K0 set in the second scenario. Then configure the HARQ-ACK codebook based on the timing K1 set in the second scenario.

In the above embodiment, the timing K1 set in the second scenario is determined based on the timing K1 set in the first scenario and the timing K0 set in the second scenario, so that the feedback window of the codebook of the timing K1 set in the second scenario can include all PDSCHs scheduled by one DCI, so that HARQ-ACK of multi-transmission time interval PDSCH can be fed back in one HARQ-ACK codebook.

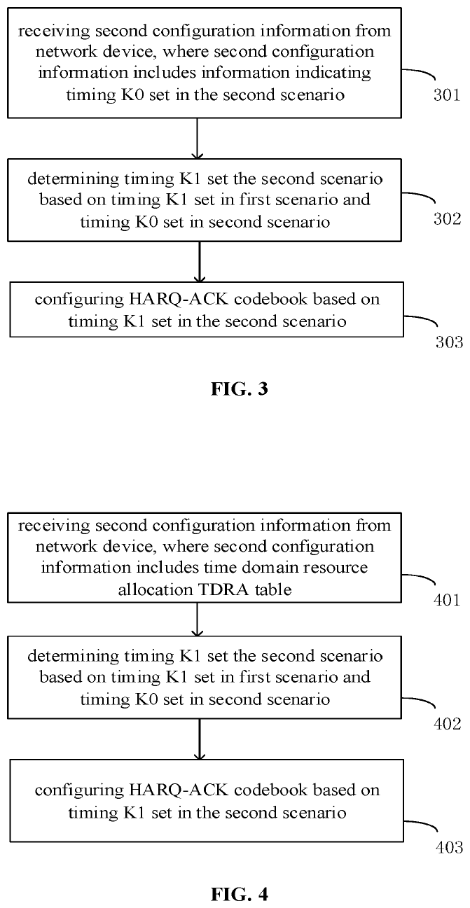

Embodiments of the present disclosure provide a HARQ-ACK codebook configuration method, which is performed by user equipment. This method can be executed independently or in conjunction with any other embodiment of the present disclosure. FIG. 3 is a flow chart of a HARQ-ACK codebook configuration method according to an exemplary embodiment. As shown in FIG. 3, the method includes:

Step 301: receiving second configuration information from the network device, where the second configuration information includes information indicating the timing K0 set in the second scenario;

Step 302: determining the timing K1 set in the second scenario based on the timing K1 set in the first scenario and the timing K0 set in the second scenario; and

Step 303: configuring the HARQ-ACK codebook based on the timing K1 set in the second scenario;
wherein, each timing k1 in the timing K1 set is the time interval between the time unit for transmitting the physical downlink shared channel (PDSCH) and the time unit for transmitting the physical uplink control channel (PUCCH), and each timing k0 in the timing K0 set is the time interval between the time unit for transmitting the PDSCH and the time unit for transmitting the physical downlink control channel (PDCCH); and
the first scenario is a scenario in which a single PDSCH time slot is scheduled through the PDCCH, and the second scenario is a scenario in which multiple PDSCH time slots are scheduled through the PDCCH.

In one implementation, the user equipment receives first configuration information from the network device, and obtains the timing K1 set in the first scenario based on the first configuration information. The user equipment receives the second configuration information from the network device, and obtains the timing K0 set in the second scenario based on the second configuration information. Furthermore, based on the timing K1 set in the first scenario and the timing K0 set in the second scenario, the timing K1 set in the second scenario is determined. Then, configure the HARQ-ACK codebook based on the timing K1 set in the second scenario. In one implementation, the second configuration information is radio resource control layer (RRC) signaling.

In one implementation, the user equipment obtains the timing K1 set in the first scenario based on the communication protocol. The user equipment receives the second configuration information from the network device, and obtains the timing K0 set in the second scenario based on the second configuration information. Furthermore, based on the timing K1 set in the first scenario and the timing K0 set in the second scenario, the timing K1 set in the second scenario is determined. Then, configure the HARQ-ACK codebook based on the timing K1 set in the second scenario.

In the above embodiment, the timing K1 set in the second scenario is determined based on the timing K1 set in the first scenario and the timing K0 set in the second scenario, so that the feedback window of the codebook of the timing K1 set in the second scenario can include all PDSCHs scheduled by one DCI, so that HARQ-ACK of multi-transmission time interval PDSCH can be fed back in one HARQ-ACK codebook.

Embodiments of the present disclosure provide a HARQ-ACK codebook configuration method, which is performed by user equipment. This method can be executed independently or in conjunction with any other embodiment of the present disclosure. FIG. 4 is a flow chart of a HARQ-ACK codebook configuration method according to an exemplary embodiment. As shown in FIG. 4, the method includes:

Step 401: receiving second configuration information from the network device, where the second configuration information includes a time domain resource allocation (TDRA) table;

Step 402: determining the timing K1 set in the second scenario based on the timing K1 set in the first scenario and the timing K0 set in the second scenario;
configuring the HARQ-ACK codebook based on the timing K1 set in the second scenario;
wherein, each timing k1 in the timing K1 set is the time interval between the time unit for transmitting the physical downlink shared channel (PDSCH) and the time unit for transmitting the physical uplink control channel (PUCCH), and each timing k0 in the timing K0 set is the time interval between the time unit for transmitting the PDSCH and the time unit for transmitting the physical downlink control channel (PDCCH); and
the first scenario is a scenario in which a single PDSCH time slot is scheduled through the PDCCH, and the second scenario is a scenario in which multiple PDSCH time slots are scheduled through the PDCCH.

In one implementation, the user equipment receives first configuration information from the network device, and obtains the timing K1 set in the first scenario based on the first configuration information. The user equipment receives the TDRA table from the network device through RRC signaling, and obtains the timing K0 set in the second scenario based on the TDRA table. Furthermore, based on the timing K1 set in the first scenario and the timing K0 set in the second scenario, the timing K1 set in the second scenario is determined. Then, configure the HARQ-ACK codebook based on the timing K1 set in the second scenario.

In one implementation, the user equipment obtains the timing K1 set in the first scenario based on the communication protocol. The user equipment receives the TDRA table from the network device, and obtains the timing K0 set in the second scenario based on the TDRA table. Furthermore, based on the timing K1 set in the first scenario and the timing K0 set in the second scenario, the timing K1 set in the second scenario is determined. Then, configure the HARQ-ACK codebook based on the timing K1 set in the second scenario.

In one embodiment, the TDRA table received by the user equipment from the network device is as shown in Table 1 above, and the user equipment obtains the timing K0 set {(0, 1, 1, 2), (1, 2, 3, 4, 5, 6, 7, 8)}.

In the above embodiment, the timing K1 set in the second scenario is determined based on the timing K1 set in the first scenario and the timing K0 set in the second scenario, so that the feedback window of the codebook of the timing K1 set in the second scenario can include all PDSCHs scheduled by one DCI, so that HARQ-ACK of multi-transmission time interval PDSCH can be fed back in one HARQ-ACK codebook.

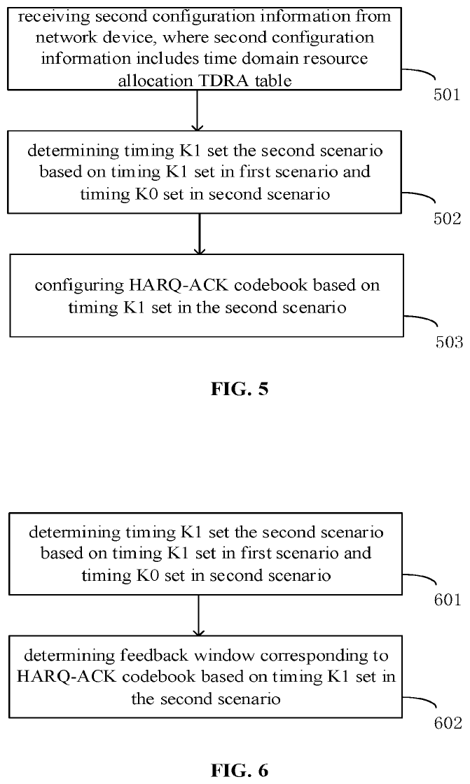

Embodiments of the present disclosure provide a HARQ-ACK codebook configuration method, which is performed by user equipment. This method can be executed independently or in conjunction with any other embodiment of the present disclosure. FIG. 5 is a flow chart of a HARQ-ACK codebook configuration method according to an exemplary embodiment. As shown in FIG. 5, the method includes:

Step 501: receiving second configuration information from the network device, where the second configuration information includes a time domain resource allocation (TDRA) table; and

Step 502: determining the timing K1 set in the second scenario based on the timing K1 set in the first scenario and the timing K0 set in the second scenario through the following formula (1):

$$\{ K {1}^{′} \} = \{ K 1 \} ⋃ {\{ k {1}_{i} + k {0}_{r , m} - k {0}_{r , min} \}}_{i = 0 , r = 0 , m = 0}^{i = L - 1 , r = R - 1 , m = {M}_{r} - 1} ; \qquad Formula 1 )$$

Step 503: configuring the HARQ-ACK codebook based on the timing K1 set in the second scenario;
wherein, each timing k1 in the timing K1 set is the time interval between the time unit for transmitting the physical downlink shared channel (PDSCH) and the time unit for transmitting the physical uplink control channel (PUCCH), and each timing k0 in the timing K0 set is the time interval between the time unit for transmitting the PDSCH and the time unit for transmitting the physical downlink control channel (PDCCH);
the first scenario is a scenario in which a single PDSCH time slot is scheduled through the PDCCH, and the second scenario is a scenario in which multiple PDSCH time slots are scheduled through the PDCCH; and
wherein, K1′ is the timing K1 set in the second scenario, K1 is the timing K1 set in the first scenario, k1ᵢ is an i-th timing k1 comprised in the timing K1 set in the first scenario, k0_{r,m} is an m-th timing k0 comprised in a r-th row containing multiple k0 in a TDRA table, k0_{r,min} is a minimum timing k0 comprised in the r-th row containing multiple k0, L is a number of timing k1 comprised in the timing K1 set in the first scenario, R is a number of rows containing multiple sequences k0 in the TDRA table, and Mᵣ is a number of timing k0 comprised in the r-th row containing multiple k0.

In one implementation, the user equipment receives first configuration information from the network device, and obtains the timing K1 set in the first scenario based on the first configuration information. The user equipment receives the TDRA table from the network device, and obtains the timing K0 set in the second scenario based on the TDRA table. Moreover, the timing K1 set in the second scenario is determined based on formula (1). Then, configure the HARQ-ACK codebook based on the timing K1 set in the second scenario.

In one implementation, the user equipment obtains the timing K1 set in the first scenario based on the communication protocol. The user equipment receives the TDRA table from the network device, and obtains the timing K0 set in the second scenario based on the TDRA table. Moreover, the timing K1 set in the second scenario is determined based on formula (1). Then, configure the HARQ-ACK codebook based on the timing K1 set in the second scenario.

In one embodiment, the user equipment uses formula (1) to determine the timing K1 set in the second scenario based on the timing K1 set in the first scenario and the timing K0 set in the second scenario.

In one implementation, the calculation process represented by formula (1) can be implemented by the following pseudocode:

```
initialize {K1′} = {K1}
for i = 0: L−1
  for r =0: R−1
    for m =0: Mᵣ −1
      {K1′} = {K1′}∪{k1ᵢ + k0_{r, m} − k0_{r, min} }
    end
  end
end
```

In one implementation, the timing K1 set is {1, 2, 3}, and the timing K0 set includes two K0 groups (0, 1, 1, 2) and (1, 2, 3, 4, 5, 6, 7, 8), correspondingly, L=3, R=2, M1=4, M2=8. Based on the above formula (1), that is, based on the above pseudo code, the calculated timing K1′ set is {1, 2, 3, 4, 5, 6, 7, 8, 9, 10}.

In the above embodiment, the timing K1 set in the second scenario is determined based on the timing K1 set in the first scenario and the timing K0 set in the second scenario, so that the feedback window of the codebook of the timing K1 set in the second scenario can include all PDSCHs scheduled by one DCI, so that HARQ-ACK of multi-transmission time interval PDSCH can be fed back in one HARQ-ACK codebook.

Embodiments of the present disclosure provide a HARQ-ACK codebook configuration method, which is performed by user equipment. This method can be executed independently or in conjunction with any other embodiment of the present disclosure. FIG. 6 is a flow chart of a HARQ-ACK codebook configuration method according to an exemplary embodiment. As shown in FIG. 6, the method includes:

Step 601: determining the timing K1 set in the second scenario based on the timing K1 set in the first scenario and the timing K0 set in the second scenario; and

Step 602: determining the feedback window corresponding to the HARQ-ACK codebook based on the timing K1 set in the second scenario;
wherein, each timing k1 in the timing K1 set is the time interval between the time unit for transmitting the physical downlink shared channel (PDSCH) and the time unit for transmitting the physical uplink control channel (PUCCH), and each timing k0 in the timing K0 set is the time interval between the time unit for transmitting the PDSCH and the time unit for transmitting the physical downlink control channel (PDCCH); and
the first scenario is a scenario in which a single PDSCH time slot is scheduled through the PDCCH, and the second scenario is a scenario in which multiple PDSCH time slots are scheduled through the PDCCH.

In one embodiment, the user equipment receives the timing K1 set in the first scenario and the timing K0 set in the second scenario from the network device, and based on the timing K1 set in the first scenario and the timing K0 set in the second scenario, determines the first timing K1 set in the second scenario. Then, based on the timing K1 set in the second scenario, the feedback window corresponding to the HARQ-ACK codebook is determined.

In one embodiment, the user equipment obtains the timing K1 set in the first scenario based on the communication protocol, and receives the timing K0 set in the second scenario from the network device, and based on the timing K1 set in the first scenario and the timing K0 set in the second scenario, determines the first timing K1 set in the second scenario. Then, based on the timing K1 set in the second scenario, the feedback window corresponding to the HARQ-ACK codebook is determined.

In the above embodiment, the timing K1 set in the second scenario is determined based on the timing K1 set in the first scenario and the timing K0 set in the second scenario, so that the feedback window of the codebook of the timing K1 set in the second scenario can include all PDSCHs scheduled by one DCI, so that HARQ-ACK of multi-transmission time interval PDSCH can be fed back in one HARQ-ACK codebook.

Embodiments of the present disclosure provide a HARQ-ACK codebook configuration method, which is performed by user equipment. This method can be executed independently or in conjunction with any other embodiment of the present disclosure. Wherein, the HARQ-ACK codebook is a Type1 codebook.

In one embodiment, the user equipment obtains the timing K1 set in the first scenario and the timing K0 set in the second scenario, and determines the timing K1 set in the second scenario based on the obtained timing K1 set and timing K0 set. Then, configure the Type1 codebook based on the timing K1 set in the second scenario.

In the above embodiment, the timing K1 set in the second scenario is determined based on the timing K1 set in the first scenario and the timing K0 set in the second scenario, so that the feedback window of the codebook of the timing K1 set in the second scenario can include all PDSCHs scheduled by one DCI, so that HARQ-ACK of multi-transmission time interval PDSCH can be fed back in one Type1 HARQ-ACK codebook.

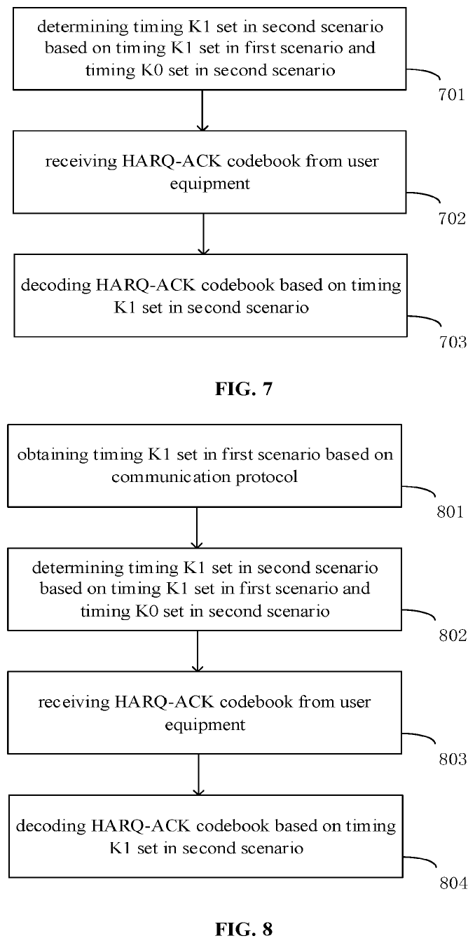

The embodiment of the present disclosure provides a HARQ-ACK codebook decoding method, which is performed by network device. This method can be executed independently or in conjunction with any other embodiment of the present disclosure. FIG. 7 is a flow chart of a HARQ-ACK codebook decoding method according to an exemplary embodiment. As shown in FIG. 7, the method includes:

Step 701: determining the timing K1 set in the second scenario based on the timing K1 set in the first scenario and the timing K0 set in the second scenario;

Step 702: receiving the HARQ-ACK codebook from the user equipment; and

Step 703: decoding the HARQ-ACK codebook based on the timing K1 set in the second scenario;

wherein, each timing K1 in the timing K1 set is the time interval between the time unit for transmitting the physical downlink shared channel (PDSCH) and the time unit for transmitting the physical uplink control channel (PUCCH), and each timing k0 in the timing K0 set is the time interval between the time unit for transmitting the PDSCH and the time unit for transmitting the physical downlink control channel (PDCCH); and

the first scenario is a scenario in which a single PDSCH time slot is scheduled through the PDCCH, and the second scenario is a scenario in which multiple PDSCH time slots are scheduled through the PDCCH.

In one embodiment, the network device obtains the timing K1 set in the first scenario and the timing K0 set in the second scenario configured by the network device for the user equipment, and determines the timing K1 set in the second scenario based on the timing K1 set in the first scenario and the timing K0 set in the second scenario. The network device receives the HARQ-ACK codebook from the user equipment and decodes the HARQ-ACK codebook based on the timing K1 set in the second scenario.

In one embodiment, the network device obtains the timing K1 set in the first scenario based on the communication protocol and obtains the timing K0 set in the second scenario configured by the network device for the user equipment, and determines the timing K1 set in the second scenario based on the timing K1 set in the first scenario and the timing K0 set in the second scenario. The network device receives the HARQ-ACK codebook from the user equipment and decodes the HARQ-ACK codebook based on the timing K1 set in the second scenario.

In the above embodiment, the timing K1 set in the second scenario is determined based on the timing K1 set in the first scenario and the timing K0 set in the second scenario, so that the feedback window of the codebook of the timing K1 set in the second scenario can include all PDSCHs scheduled by one DCI, so that HARQ-ACK of multi-transmission time interval PDSCH can be fed back in one HARQ-ACK codebook. Therefore, network device can accurately decode the HARQ-ACK codebook and achieve efficient hybrid automatic retransmission.

The embodiment of the present disclosure provides a HARQ-ACK codebook decoding method, which is performed by network device; the method can be executed independently, or can be executed in conjunction with any other embodiment of the embodiment of the present disclosure. In the embodiment, the timing K0 set in the second scenario includes at least one timing K0 group, and the timing K0 group includes a plurality of timing k0 corresponding to a time domain resource scheduling mode in the second scenario.

In one embodiment, the timing K0 set in the second scenario includes multiple timing K0 groups, each timing K0 group includes multiple timing k0, and each timing K0 group corresponds to a time domain resource scheduling mode in the second scenario.

In one implementation, the network device obtains the timing K0 set in the second scenario based on the TDRA table configured by the network device for the user equipment. For the TDRA table and the method of obtaining the timing K0 set based on the TDRA table, please refer to the above descriptions of other embodiments, which will not be described again here.

In the above embodiment, the timing K1 set in the second scenario is determined in combination with the timing K0 set in the second scenario, so that the feedback window of the codebook based on the timing K1 set in the second scenario can include all the PDSCHs scheduled by one DCI, so that the HARQ-ACK of the multi-transmission time interval PDSCH can be fed back in one HARQ-ACK codebook.

The embodiment of the present disclosure provides a HARQ-ACK codebook decoding method, which is performed by network device. This method can be executed independently or in conjunction with any other embodiment of the present disclosure. FIG. 8 is a flow chart of a HARQ-ACK codebook decoding method according to an exemplary embodiment. As shown in FIG. 8, the method includes:

Step 801: obtaining the timing K1 set in the first scenario based on the communication protocol;

Step 802: determining the timing K1 set in the second scenario based on the timing K1 set in the first scenario and the timing K0 set in the second scenario;

Step 803, receiving the HARQ-ACK codebook from the user equipment; and

Step 804: decoding the HARQ-ACK codebook based on the timing K1 set in the second scenario;

wherein, each timing K1 in the timing K1 set is the time interval between the time unit for transmitting the physical downlink shared channel (PDSCH) and the time unit for transmitting the physical uplink control channel (PUCCH), and each timing k0 in the timing K0 set is the time interval between the time unit for transmitting the PDSCH and the time unit for transmitting the physical downlink control channel (PDCCH); and

the first scenario is a scenario in which a single PDSCH time slot is scheduled through the PDCCH, and the second scenario is a scenario in which multiple PDSCH time slots are scheduled through the PDCCH.

In one embodiment, the network device obtains the timing K1 set in the first scenario based on the communication protocol, and determines the timing K1 set in the second scenario based on the timing K1 set in the first scenario and the timing K0 set in the second scenario. After receiving the HARQ-ACK codebook from the user equipment, the HARQ-ACK codebook is decoded based on the timing K1 set in the second scenario.

In the above embodiment, the timing K1 set in the second scenario is determined based on the timing K1 set in the first scenario and the timing K0 set in the second scenario, so that the feedback window of the codebook of the timing K1 set in the second scenario can include all PDSCHs scheduled by one DCI, so that HARQ-ACK of multi-transmission time interval PDSCH can be fed back in one HARQ-ACK codebook. Therefore, network device can accurately decode the HARQ-ACK codebook and achieve efficient hybrid automatic retransmission.

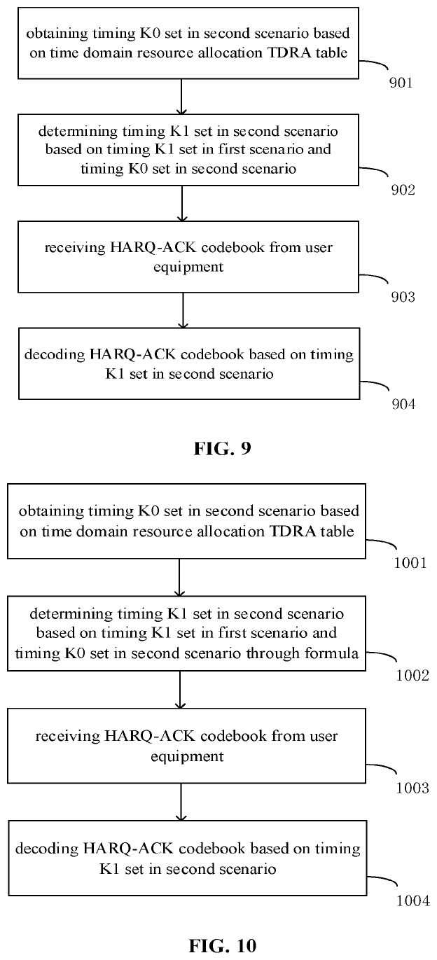

The embodiment of the present disclosure provides a HARQ-ACK codebook decoding method, which is performed by network device. This method can be executed independently or in conjunction with any other embodiment of the present disclosure. FIG. 9 is a flow chart of a HARQ-ACK codebook decoding method according to an exemplary embodiment. As shown in FIG. 9, the method includes:

Step 901: obtaining the timing K0 set in the second scenario based on the time domain resource allocation (TDRA) table;

Step 902: determining the timing K1 set in the second scenario based on the timing K1 set in the first scenario and the timing K0 set in the second scenario;

Step 903: receiving the HARQ-ACK codebook from the user equipment; and

Step 904: decoding the HARQ-ACK codebook based on the timing K1 set in the second scenario;

wherein, each timing K1 in the timing K1 set is the time interval between the time unit for transmitting the physical downlink shared channel (PDSCH) and the time unit for transmitting the physical uplink control channel (PUCCH), and each timing k0 in the timing K0 set is the time interval between the time unit for transmitting the PDSCH and the time unit for transmitting the physical downlink control channel (PDCCH); and

the first scenario is a scenario in which a single PDSCH time slot is scheduled through the PDCCH, and the second scenario is a scenario in which multiple PDSCH time slots are scheduled through the PDCCH.

In one embodiment, the network device obtains the timing K0 set in the second scenario based on the TDRA table configured by the network device for the user equipment, and then determines the timing K1 set in the second scenario based on the timing K1 set in the first scenario and the timing K0 set in the second scenario. After receiving the HARQ-ACK codebook from the user equipment, the HARQ-ACK codebook is decoded based on the timing K1 set in the second scenario.

In one embodiment, the TDRA table configured by the network device is as shown in Table 1 above, and the network device obtains the timing K0 set in the second scenario {(0, 1, 1, 2), (1, 2, 3, 4, 5, 6, 7, 8)}.

In the above embodiment, the timing K1 set in the second scenario is determined based on the timing K1 set in the first scenario and the timing K0 set in the second scenario, so that the feedback window of the codebook of the timing K1 set in the second scenario can include all PDSCHs scheduled by one DCI, so that HARQ-ACK of multi-transmission time interval PDSCH can be fed back in one HARQ-ACK codebook. Therefore, network device can accurately decode the HARQ-ACK codebook and achieve efficient hybrid automatic retransmission.

The embodiment of the present disclosure provides a HARQ-ACK codebook decoding method, which is performed by network device. This method can be executed independently or in conjunction with any other embodiment of the present disclosure. FIG. 10 is a flow chart of a HARQ-ACK codebook decoding method according to an exemplary embodiment. As shown in FIG. 10, the method includes:

Step 1001, obtaining the timing K0 set in the second scenario based on the time domain resource allocation (TDRA) table;

Step 1002: determining the timing K1 set in the second scenario based on the timing K1 set in the first scenario and the timing K0 set in the second scenario through the following formula (1):

$$\{ K {1}^{′} \} = \{ K 1 \} ⋃ {\{ k {1}_{i} + k {0}_{r , m} - k {0}_{r , min} \}}_{i = 0 , r = 0 , m = 0}^{i = L 1 , r = R 1 , m = {M}_{r} 1} ; \qquad Formula ( 1 )$$

Step 1003, receiving the HARQ-ACK codebook from the user equipment; and

Step 1004, decoding the HARQ-ACK codebook based on the timing K1 set in the second scenario;

wherein, each timing K1 in the timing K1 set is the time interval between the time unit for transmitting the physical downlink shared channel (PDSCH) and the time unit for transmitting the physical uplink control channel (PUCCH), and each timing k0 in the timing K0 set is the time interval between the time unit for transmitting the PDSCH and the time unit for transmitting the physical downlink control channel (PDCCH); and

the first scenario is a scenario in which a single PDSCH time slot is scheduled through the PDCCH, and the second scenario is a scenario in which multiple PDSCH time slots are scheduled through the PDCCH;

wherein, K1′ is the timing K1 set in the second scenario, K1 is the timing K1 set in the first scenario, k1ᵢ is an i-th timing k1 comprised in the timing K1 set in the first scenario, k0_{r,m} is an m-th timing k0 comprised in a r-th row containing multiple k0 in a TDRA table, k0_{r,min} is a minimum timing k0 comprised in the r-th row containing multiple k0, L is a number of timing k1 comprised in the timing K1 set in the first scenario, R is a number of rows containing multiple sequences k0 in the TDRA table, and Mᵣ is a number of timing k0 comprised in the r-th row containing multiple k0.

In one implementation, the network device obtains the timing K0 set in the second scenario based on the TDRA table configured by the network device. Moreover, the timing K1 set in the second scenario is determined based on formula (1). After receiving the HARQ-ACK codebook from the user equipment, the HARQ-ACK codebook is decoded based on the timing K1 set in the second scenario.

The process by which the network device calculates through formula (1) to obtain the timing K1 set in the second scenario is similar to the process in which the user equipment obtains the timing K1 set in the second scenario in the above embodiment.

In the above embodiment, the timing K1 set in the second scenario is determined based on the timing K1 set in the first scenario and the timing K0 set in the second scenario, so that the feedback window of the codebook of the timing K1 set in the second scenario can include all PDSCHs scheduled by one DCI, so that HARQ-ACK of multi-transmission time interval PDSCH can be fed back in one HARQ-ACK codebook. Therefore, network device can accurately decode the HARQ-ACK codebook and achieve efficient hybrid automatic retransmission.

Embodiments of the present disclosure provide a HARQ-ACK codebook decoding method, which is performed by the user equipment. This method can be executed independently or in conjunction with any other embodiment of the present disclosure. Wherein, the HARQ-ACK codebook is a Type1 codebook.

In one embodiment, the network device determines the timing K1 set in the second scenario based on the timing K1 set in the first scenario and the timing K0 set in the second scenario. After receiving the Type1 codebook from the user equipment, the Type1 codebook is decoded based on the timing K1 set in the second scenario.

In the above embodiment, the timing K1 set in the second scenario is determined based on the timing K1 set in the first scenario and the timing KG set in the second scenario, so that the feedback window of the codebook of the timing K1 set in the second scenario can include all PDSCHs scheduled by one DCI, so that HARQ-ACK of multi-transmission time interval PDSCH can be fed back in one HARQ-ACK codebook. Therefore, network device can accurately decode the HARQ-ACK codebook and achieve efficient hybrid automatic retransmission.

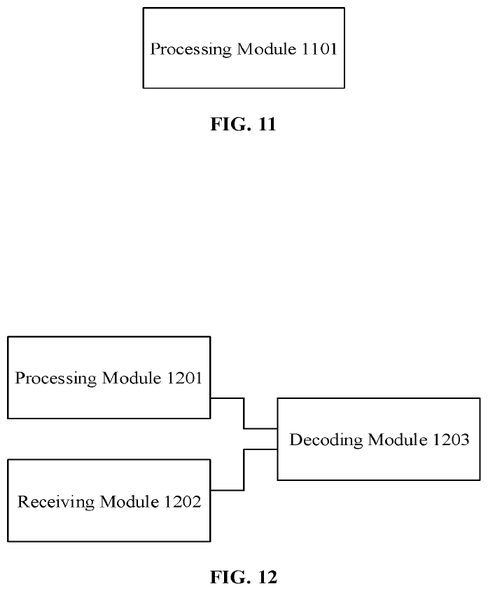

Embodiments of the present disclosure provide a hybrid automatic repeat request acknowledgment (HARQ-ACK) response codebook configuration apparatus, which is applied to user equipment. Referring to FIG. 11, the device includes:
a processing module 1101, configured to determine the timing K1 set in the second scenario based on the timing K1 set in the first scenario and the timing K0 set in the second scenario, and configure the HARQ-ACK codebook based on the timing K1 set in the second scenario;
wherein, each timing K1 in the timing K1 set is the time interval between the time unit for transmitting the physical downlink shared channel (PDSCH) and the time unit for transmitting the physical uplink control channel (PUCCH), and each timing k0 in the timing K0 set is the time interval between the time unit for transmitting the PDSCH and the time unit for transmitting the physical downlink control channel (PDCCH); and
the first scenario is a scenario in which a single PDSCH time slot is scheduled through the PDCCH, and the second scenario is a scenario in which multiple PDSCH time slots are scheduled through the PDCCH.

The embodiment of the present disclosure provides a hybrid automatic repeat request acknowledgment (HARQ-ACK) response codebook decoding apparatus, which is applied to network device. Referring to FIG. 12, the device includes:
a processing module 1201, configured to determine the timing K1 set in the second scenario based on the timing K1 set in the first scenario and the timing K0 set in the second scenario;
a receiving module 1202, configured to receive the HARQ-ACK codebook from the user equipment; and
a decoding module 1203, configured to decode the HARQ-ACK codebook based on the timing K1 set in the second scenario;
wherein, each timing K1 in the timing K1 set is the time interval between the time unit for transmitting the physical downlink shared channel (PDSCH) and the time unit for transmitting the physical uplink control channel (PUCCH), and each timing k0 in the timing K0 set is the time interval between the time unit for transmitting the PDSCH and the time unit for transmitting the physical downlink control channel (PDCCH); and
the first scenario is a scenario in which a single PDSCH time slot is scheduled through the PDCCH, and the second scenario is a scenario in which multiple PDSCH time slots are scheduled through the PDCCH.

An embodiment of the present disclosure provides a mobile terminal, including:
a processor; and
a memory configured to store instructions executable by the processor;
wherein, the processor is configured to execute the executable instructions in the memory to implement the steps of the above hybrid automatic repeat request acknowledgment (HARQ-ACK) response codebook configuration method.

Embodiments of the present disclosure provide a network side device, including:
a processor; and
a memory configured to store instructions executable by the processor;
wherein, the processor is configured to execute executable instructions in the memory to implement the steps of the above hybrid automatic repeat request acknowledgment (HARQ-ACK) response codebook decoding method.

Embodiments of the present disclosure provide a non-transitory computer-readable storage medium on which executable instructions are stored. When the executable instructions are executed by a processor, the steps of the above hybrid automatic repeat request acknowledgment (HARQ-ACK) response codebook configuration method or the above HARQ-ACK codebook decoding method are implemented.

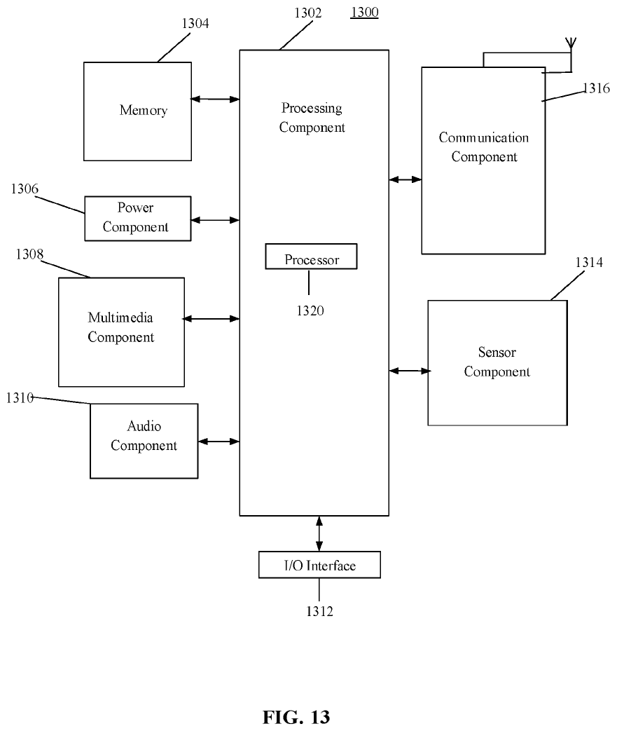

FIG. 13 is a block diagram of a device 1300 for HARQ-ACK codebook configuration according to an exemplary embodiment. For example, the device 1300 may be a mobile phone, a computer, a digital broadcast terminal, a messaging device, a game console, a tablet device, a medical device, a fitness device, a personal digital assistant, or the like.

Referring to FIG. 13, the device 1300 may include one or more of the following components: a processing component 1302, a memory 1304, a power supply component 1306, a multimedia component 1308, an audio component 1310, an input/output (I/O) interface 1312, a sensor component 1314, and a communication component 1316.

The processing component 1302 generally controls the overall operations of the device 1300, such as operations associated with display, telephone calls, data communications, camera operations, and recording operations. The processing component 1302 may include one or more processors 1320 to execute instructions to complete all or part of the steps of the above method. Additionally, processing component 1302 may include one or more modules that facilitate interaction between processing component 1302 and other components. For example, processing component 1302 may include a multimedia module to facilitate interaction between multimedia component 1308 and processing component 1302.

The memory 1304 is configured to store various types of data to support operations at the device 1300. Examples of such data include instructions for any application or method operating on the device 1300, contact data, phonebook data, messages, pictures, videos, etc. The memory 1304 can be realized by any type of volatile or non-volatile storage device or their combination, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power supply component 1306 provides power to various components of the device 1300. The power component 1306 may include a power management system, one or more power supplies, and other components associated with generating, managing, and distributing power for device 1300.

The multimedia component 1308 includes a screen providing an output interface between the device 1300 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or a swipe action, but also detect duration and pressure associated with the touch or swipe operation. In some embodiments, the multimedia component 1308 includes a front camera and/or a rear camera. When the device 1300 is in an operation mode, such as a photographing mode or a video mode, the front camera and/or the rear camera can receive external multimedia data. Each front camera and rear camera can be a fixed optical lens system or have focal length and optical zoom capability.

The audio component 1310 is configured to output and/or input audio signals. For example, the audio component 1310 includes a microphone (MIC), which is configured to receive an external audio signal when the device 1300 is in an operation mode, such as a call mode, a recording mode and a voice recognition mode. Received audio signals may be further stored in memory 1304 or sent via communication component 1316. In some embodiments, the audio component 1310 also includes a speaker for outputting audio signals.

The I/O interface 1312 provides an interface between the processing component 1302 and a peripheral interface module, which may be a keyboard, a click wheel, a button, and the like. These buttons may include, but are not limited to: a home button, volume buttons, start button, and lock button.

The sensor component 1314 includes one or more sensors for providing device 1300 with various aspects of status assessment. For example, the sensor component 1314 can detect the open/closed state of the device 1300, the relative positioning of components, such as the display and the keypad of the device 1300, the sensor component 1314 can also detect the device 1300 or a change in the position of a component of the device 1300, the presence or absence of user's contact with the device 1300, the change of orientation or acceleration/deceleration of the device 1300 and the temperature change of the device 1300. The sensor component 1314 may include a proximity sensor configured to detect the presence of nearby objects in the absence of any physical contact. The sensor component 1314 may also include an optical sensor, such as a CMOS or CCD image sensor, for use in imaging applications. In some embodiments, the sensor component 1314 may also include an acceleration sensor, a gyroscope sensor, a magnetic sensor, a pressure sensor or a temperature sensor.

The communication component 1316 is configured to facilitate wired or wireless communication between the device 1300 and other devices. The device 1300 can access a wireless network based on communication standards, such as Wi-Fi, 2G or 3G, or a combination thereof. In an exemplary embodiment, the communication component 1316 receives broadcast signals or broadcast related information from an external broadcast management system via a broadcast channel. In an exemplary embodiment, the communication component 1316 also includes a near field communication (NFC) module to facilitate short-range communication. For example, the NFC module can be implemented based on radio frequency identification (RFID) technology, infrared data association (IrDA) technology, ultra wideband (UWB) technology, bluetooth (BT) technology and other technologies.

In an exemplary embodiment, device 1300 may be implemented by one or more application specific integrated circuits (ASIC), digital signal processors (DSP), digital signal processing devices (DSPD), programmable logic devices (PLD), field programmable gate array (FPGA), controllers, microcontrollers, microprocessors or other electronic components for performing the method described above.

In an exemplary embodiment, there is also provided a non-transitory computer-readable storage medium including instructions, such as the memory 1304 including instructions, which can be executed by the processor 1320 of the device 1300 to implement the above method. For example, the non-transitory computer readable storage medium may be ROM, random access memory (RAM), CD-ROM, magnetic tape, floppy disk, and optical data storage device, and the like.

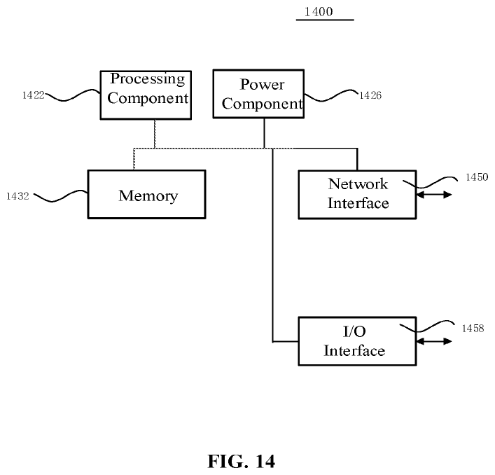

FIG. 14 is a block diagram illustrating a device 1400 for decoding the HARQ-ACK codebook according to an exemplary embodiment. For example, the device 1400 may be provided as a base station. Referring to FIG. 14, the device 1400 includes a processing component 1422, which further includes one or more processors, and a memory resource represented by a memory 1432 for storing instructions executable by the processing component 1422, such as application programs. The application program stored in memory 1432 may include one or more modules each corresponding to a set of instructions. In addition, the processing component 1422 is configured to execute instructions, so as to perform the above method for accessing unlicensed channel.

The device 1400 may also include a power component 1426 configured to perform power management of device 1400, a wired or wireless network interface 1450 configured to connect device 1400 to a network, and an input-output (I/O) interface 1458. The device 1400 can operate based on an operating system stored in the memory 1432, such as Windows Server™, Mac OS X™, Unix™, Linux™, FreeBSD™ or the like.

Other embodiments of the embodiment of the present disclosure will be readily apparent to those skilled in the art from consideration of the specification and practice of the invention disclosed herein. This application is intended to cover any modification, use or adaptation of the embodiment of the present disclosure, these modifications, uses or adaptations follow the general principles of the embodiment of the present disclosure and include common knowledge or conventional technical means in the technical field not disclosed in this disclosure. The specification and examples are to be considered exemplary only, with a true scope and spirit of the embodiment of the present disclosure being indicated by the following claims.

It should be understood that the embodiment of the present disclosure is not limited to the precise constructions which have been described above and shown in the accompanying drawings, and various modifications and changes may be made without departing from the scope thereof. The scope of the embodiment of the present disclosure is limited only by the appended claims.

### INDUSTRIAL APPLICABILITY

The technical solution provided by the embodiments of the present disclosure may include the following beneficial effects: the timing K1 set in the second scenario is determined in combination with the timing K0 set in the second scenario, so that the feedback window of the codebook based on the timing K1 set in the second scenario can include all PDSCHs scheduled by one DCI, so that HARQ-ACK of multi-transmission time interval PDSCH can be fed back in one HARQ-ACK codebook. Moreover, network device can accurately decode the HARQ-ACK codebook to achieve efficient hybrid automatic retransmission.

What is claimed is:

1. A method for configurating a hybrid automatic repeat request acknowledgment (HARQ-ACK) response codebook, performed by user equipment, comprising:
determining a timing K1 set in a second scenario based on a timing K1 set in a first scenario and a timing KG set in the second scenario; and
configuring the HARQ-ACK codebook based on the timing K1 set in the second scenario;
wherein, each timing k1 in the timing K1 set is a time interval between a time unit for transmitting a physical downlink shared channel (PDSCH) and a time unit for transmitting a physical uplink control channel (PUCCH), and each timing k0 in the timing KG set is a time interval between the time unit for transmitting the physical downlink shared channel (PD SCH) and a time unit of transmitting a physical downlink control channel (PDCCH); and
the first scenario is a scenario in which a single PDSCH time slot is scheduled through the PDCCH, and the second scenario is a scenario in which multiple PDSCH time slots are scheduled through the PDCCH.

2. The method according to claim 1, wherein the timing KG set in the second scenario comprises at least one timing K0 group, each timing KG group comprises a plurality of timing K0, and each timing K0 group corresponds to a time domain resource scheduling mode in the second scenario.

3. The method according to claim 1, further comprising:
receiving first configuration information from a network device, wherein the first configuration information comprises information indicating the timing K1 set in the first scenario; or
obtaining the timing K1 set in the first scenario based on a communication protocol.

4. The method according to claim 1, further comprising:
receiving second configuration information from a network device, wherein the second configuration information comprises information indicating the timing K0 set in the second scenario.

5. The method according to claim 1, further comprising:
receiving second configuration information from a network device, wherein the second configuration information comprises a time domain resource allocation (TDRA) table.

6. The method according to claim 5, wherein determining the timing K1 set in the second scenario based on the timing K1 set in the first scenario and the timing K0 set in the second scenario comprises determining the timing K1 set in the second scenario based on following formula:
$$\{ K {1}^{′} \} = \{ K 1 \} ⋃ {\{ k {1}_{i} + k {0}_{r , m} - k {0}_{r , min} \}}_{i = 0 , r = 0 , m = 0}^{i - L - 1 , r - R - 1 , m - {M}_{r} - 1}$$
wherein, K1′ is the timing K1 set in the second scenario, K1 is the timing K1 set in the first scenario, k1ᵢ is an i-th timing k1 comprised in the timing K1 set in the first scenario, k0_{r,m} is an m-th timing k0 comprised in a r-th row containing multiple k0 in a TDRA table, k0_{r,m} in is a minimum timing k0 comprised in the r-th row containing multiple k0, L is a number of timing k1 comprised in the timing K1 set in the first scenario, R is a number of rows containing multiple sequences k0 in the TDRA table, and Mᵣ is a number of timing k0 comprised in the r-th row containing multiple k0.

7. The method according to claim 1, wherein configuring the HARQ-ACK codebook based on the timing K1 set in the second scenario comprises:
determining a feedback window corresponding to the HARQ-ACK codebook based on the timing K1 set in the second scenario.

8. The method according to claim 1, wherein the HARQ-ACK codebook is a Type1 codebook.

9. A method for decoding a hybrid automatic repeat request acknowledgment (HARQ-ACK) response codebook, performed by network device, comprising:
determining a timing K1 set in a second scenario based on a timing K1 set in a first scenario and a timing KG set in the second scenario;
receiving the HARQ-ACK codebook from a user equipment; and
decoding the HARQ-ACK codebook based on the timing K1 set in the second scenario;
wherein, each timing k1 in the timing K1 set is a time interval between a time unit for transmitting a physical downlink shared channel (PDSCH) and a time unit for transmitting a physical uplink control channel (PUCCH), and each timing k0 in the timing K0 set is a time interval between the time unit for transmitting the physical downlink shared channel (PD SCH) and a time unit of transmitting a physical downlink control channel (PDCCH); and
the first scenario is a scenario in which a single PDSCH time slot is scheduled through the PDCCH, and the second scenario is a scenario in which multiple PDSCH time slots are scheduled through the PDCCH.

10. The method according to claim 9, wherein the timing KG set in the second scenario comprises at least one timing K0 group, and the timing K0 group corresponds to a plurality of timing k0 of a time domain resource scheduling mode in the second scenario.

11. The method according to claim 9, further comprising:
obtaining the timing K1 set in the first scenario based on a communication protocol.

12. The method according to claim 9, further comprising:
obtaining the timing KG set in the second scenario based on a time domain resource allocation (TDRA) table.

13. The method according to claim 12, wherein determining the timing K1 set in the second scenario based on the timing K1 set in the first scenario and the timing K0 set in the second scenario comprises determining the timing K1 set in the second scenario based on following formula:
$$\{ K {1}^{′} \} = \{ K 1 \} ⋃ {\{ k {1}_{i} + k {0}_{r , m} - k {0}_{r , min} \}}_{i = 0 , r = 0 , m = 0}^{i = L - 1 , r = R - 1 , m = {M}_{r} - 1}$$
wherein, K1′ is the timing K1 set in the second scenario, K1 is the timing K1 set in the first scenario, k1ᵢ is an i-th timing k1 comprised in the timing K1 set in the first scenario, k0_{r,m} is an m-th timing k0 comprised in a r-th row containing multiple k0 in a TDRA table, k0_{r,min} is a minimum timing k0 comprised in the r-th row containing multiple k0, L is a number of timing k1 comprised in the timing K1 set in the first scenario, R is a number of rows containing multiple sequences k0 in the TDRA table, and Mᵣ is a number of timing k0 comprised in the r-th row containing multiple k0.

14. The method according to claim 9, wherein the HARQ-ACK codebook is a Type1 codebook.

15. An apparatus for configurating a hybrid automatic repeat request acknowledgment (HARQ-ACK) response codebook, applied in a user equipment and comprising:
a processing module, configured to determine a timing K1 set in a second scenario based on a timing K1 set in a first scenario and a timing K0 set in the second scenario; and
configure the HARQ-ACK codebook based on the timing K1 set in the second scenario;
wherein, each timing k1 in the timing K1 set is a time interval between a time unit for transmitting a physical downlink shared channel (PDSCH) and a time unit for transmitting a physical uplink control channel (PUCCH), and each timing k0 in the timing K0 set is a time interval between the time unit for transmitting the physical downlink shared channel (PDSCH) and a time unit of transmitting a physical downlink control channel (PDCCH); and
the first scenario is a scenario in which a single PDSCH time slot is scheduled through the PDCCH, and the second scenario is a scenario in which multiple PDSCH time slots are scheduled through the PDCCH.

16. An apparatus for decoding a hybrid automatic repeat request acknowledgment (HARQ-ACK) response codebook, applied in a network device and comprising:
a processing module, configured to determine a timing K1 set in a second scenario based on a timing K1 set in a first scenario and a timing K0 set in the second scenario;
a receiving module, configured to receive the HARQ-ACK codebook from a user equipment; and
a decoding module, configured to decode the HARQ-ACK codebook based on the timing K1 set in the second scenario;
wherein, each timing k1 in the timing K1 set is a time interval between a time unit for transmitting a physical downlink shared channel (PDSCH) and a time unit for transmitting a physical uplink control channel (PUCCH), and each timing k0 in the timing K0 set is a time interval between the time unit for transmitting the physical downlink shared channel (PD SCH) and a time unit of transmitting a physical downlink control channel (PDCCH); and
the first scenario is a scenario in which a single PDSCH time slot is scheduled through the PDCCH, and the second scenario is a scenario in which multiple PDSCH time slots are scheduled through the PDCCH.

17. A mobile terminal, comprising:
a processor; and
a memory configured to store executable instructions of the processor;
wherein, the processor is configured to execute the executable instructions in the memory to implement steps of the method for configuring the hybrid automatic repeat request acknowledgment (HARQ-ACK) response codebook according to any one of claims 1 to 8.

18. A network side device, comprising:
a processor; and
a memory configured to store executable instructions of the processor;
Wherein, the processor is configured to execute the executable instructions in the memory to implement steps of the method for decoding the hybrid automatic repeat request acknowledgment (HARQ-ACK) response codebook according to any one of claims 9 to 14.

19. A non-transitory computer-readable storage medium having executable instructions stored thereon, wherein when the executable instructions are performed by processor, steps of the method for configuring the hybrid automatic repeat request acknowledgment (HARQ-ACK) response codebook according to any one of claims 1 to 8 or the method for decoding the hybrid automatic repeat request acknowledgment (HARQ-ACK) response codebook according to any one of claims 9 to 14 are implemented.
